(19) United States
(12) Patent Application Publication
(10) Pub. No.: US 2025/0285154 A1
(43) Pub. Date: Sep. 11, 2025

(54) SYSTEM FOR COLLECTING, MANAGING, SHARING, PROVIDING SOCIAL MEDIA, AND TRADING ITEM DATA ON USER TERMINAL DEVICE BASED ON MY DATA

(71) Applicant: Seok Min SEON, Seoul (KR)

(72) Inventor: Seok Min SEON, Seoul (KR)

(21) Appl. No.: 19/105,031

(22) PCT Filed: Sep. 6, 2022
(86) PCT No.: PCT/KR2022/013340

§ 371 Date: Feb. 19, 2025

(30) Foreign Application Priority Data
Aug. 25, 2022 (KR) 10-2022-0106690

(51) Int. Cl. G06Q 30/0601; G06Q 30/0201; G06Q 50/00

(52) U.S. Cl. CPC G06Q 30/0619; G06Q 30/0201; G06Q 30/0625; G06Q 30/0643; G06Q 50/01

(57) ABSTRACT

A system for managing a fashion item includes a server and user terminals that are accessible to the server and on which a predetermined application is installed, in which the user terminals may be owned by users including a first user, a second user, and a third user, each of the users may issue data by entering an image of a fashion item that the user owns and attribute information including at least one of a purchase year, a brand, a purchase price, a type, or a purchase receipt image of the fashion item into the application.

### TECHNICAL FIELD

The present invention relates to a method and system for managing and sharing personal fashion items using a user terminal.

### BACKGROUND ART

Young people in their 20s and 30s (the so-called MZ generation) purchase two or more fashion items every month for self-satisfaction and continuously purchase fashion items to express themselves. Due to the phenomenon of preference for consumption for self-satisfaction represented by keywords such as “flex” and “splurge fun,” the fashion item consumption of the MZ generation has explosively increased, and fashion platform sales have significantly grown over the past three years.

The increase in purchases and consumption of fashion items by the people may rapidly increase the amount of unused fashion items. According to a survey, the MZ generation is leaving more than 75% of their fashion items unused, and 86% of the MZ generation purchases more than 24 fashion items a year, but many of them are left unused.

People are using second-hand transaction platforms to dispose of items they own, but there is a problem that a second-hand transaction is cumbersome and makes it difficult to quickly dispose of items left unused. This phenomenon is not limited to fashion items, but is also seen in various collectible items, such as electronic products, records, souvenirs, photographs, watches, and the like.

There is a culture of uploading items that people have purchased and publicizing them on social media such as Instagram and Facebook, and there are platforms where people having similar tastes and interests gather to share purchased items and exchange information in online communities. In addition, there are platforms for second-hand transactions such as Joonggonara and Danggeun Market.

However, not only is there no system or method for managing a fashion item a person owns on a user terminal such as a smartphone, but there is also no integrated platform for the younger generation who consume a lot of fashion items to show off their fashion items to others, share various stories about fashion items, and trade second-hand items.

### DISCLOSURE OF THE INVENTION

### Technical Problem

A system and method may be provided that allows the MZ generation, which is a digital native, to manage various items, including their fashion items, through user terminals such as smartphones.

The technical problem to be solved by the present embodiment is not limited to the technical problem described above, and other technical problems could be inferred from the following embodiments.

### Technical Solution

A system and method may be provided that allows the MZ generation, which is a digital native, to manage various items, including their fashion items, through user terminals such as smartphones.

### Advantageous Effects

By checking an inventory before purchasing a fashion item, it is possible to prevent overconsumption, and by sharing fashion items that have been purchased or owned with others, it is possible to satisfy the desire of the younger generation to show off and brag. In addition, by selecting keywords that represent fashion tastes, it is possible to form a network with users who have similar tastes, interests, and fashion styles to share users' own fashion item lists, and quickly sell their items to users having similar tastes.

By spreading the culture of managing items and introducing unused items into the second-hand market, it is possible to reduce clothing waste, thereby contributing to environmental protection.

### BRIEF DESCRIPTION OF THE DRAWINGS

FIG. 1 shows a system for managing a fashion item according to one embodiment.

FIG. 2 shows data archives stored on a server according to one embodiment.

FIGS. 3 to 9 show user interfaces implemented on a user terminal according to one embodiment.

FIG. 10 shows a data archive after a second-hand transaction is completed, according to one embodiment.

### BEST MODE FOR CARRYING OUT THE INVENTION

There is provided a system for managing a fashion item including a server and user terminals that are accessible to the server and on which a predetermined application is installed, in which the user terminals are owned by users including a first user, a second user, and a third user, each of the users issues data by entering an image of a fashion item that the user owns and attribute information including at least one of a purchase year, a brand, a purchase price, a type, or a purchase receipt image of the fashion item into the application, the server stores a data archive of each of the users including the data of each of the users, the second user is able to retrieve the fashion item owned by the first user by retrieving the data archive of the first user, the purchase receipt image for the fashion item not being exposed to the second user, a state of a second-hand transaction target item that is one of a plurality of fashion items stored in the data archive of the first user is changed to a for-sale state and displayed to the users by the first user registering the second-hand transaction target item as a sale item in a second-hand market, the second user and the third user are able to check the purchase receipt image for the second-hand transaction target item, and the state of the second-hand transaction target item is changed to an in-transaction state and displayed to the users by the third user expressing an intention to transact to the first user, and each of the users selects at least one of fashion style keywords listed on the application, and the server provides the first user with a list of users whose preferred fashion style is similar to the first user based on the selected fashion style keyword.

In the system, when the transaction is completed, the state of the second-hand transaction target item may be changed to a transaction-completed state and displayed to the users, and data of the second-hand transaction target item may be moved from an account of the first user to an account of the third user.

The attribute information may further include a unique product number of the fashion item, the server may provide second-hand market price information about the fashion item based on the unique product number, and when the transaction is completed, a transaction price of the second-hand transaction target item may be uploaded to the server so that the transaction price is reflected in the second-hand market price information.

Second-hand transaction target goods of the second-hand market may be differently exposed to each user, a second-hand transaction target item registered by a user whose preferred fashion style is similar to the first user may be first exposed to the second-hand market displayed on the user terminal of the first user, and a second-hand transaction target item registered by a user whose preferred fashion style is similar to the second user may be first exposed to the second-hand market displayed on the user terminal of the second user.

### MODE FOR CARRYING OUT THE INVENTION

In the following, several embodiments will be described clearly and in detail with reference to the accompanying drawings so that those having ordinary skill in the art (hereinafter referred to as those skilled in the art) to which the present invention belongs may easily practice the present invention.

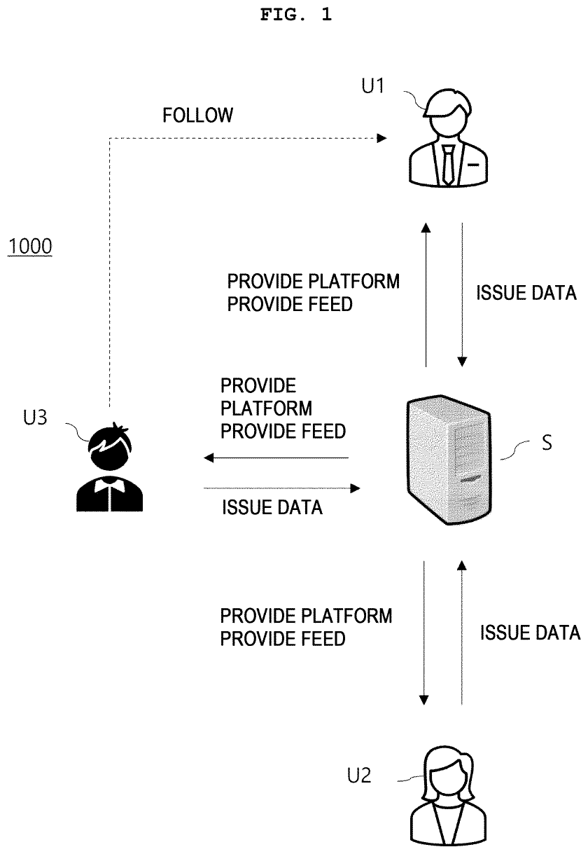

FIG. 1 shows a system for managing a fashion item according to one embodiment.

A system 1000 for managing a fashion item (hereinafter referred to as a system) may provide a service for managing items (objects) based on data. Users may manage their fashion items using their smartphones without having to search their closets or shoe cabinets, may select items that are used less frequently before they are left unattended and check the second-hand market price, and may quickly cash in on the items by being recommended other users who share a common fashion style.

The system 1000 may include a server S and user terminals of users U1, U2, U3, . . . .

The user terminals are devices that may connect to the server S, and may include electronic devices such as smartphones, tablet PCs, PCs, laptops, and smart watches owned by each of the users U1, U2, U3, . . . . Hereinafter, a user may refer to one of the users U1, U2, U3, . . . .

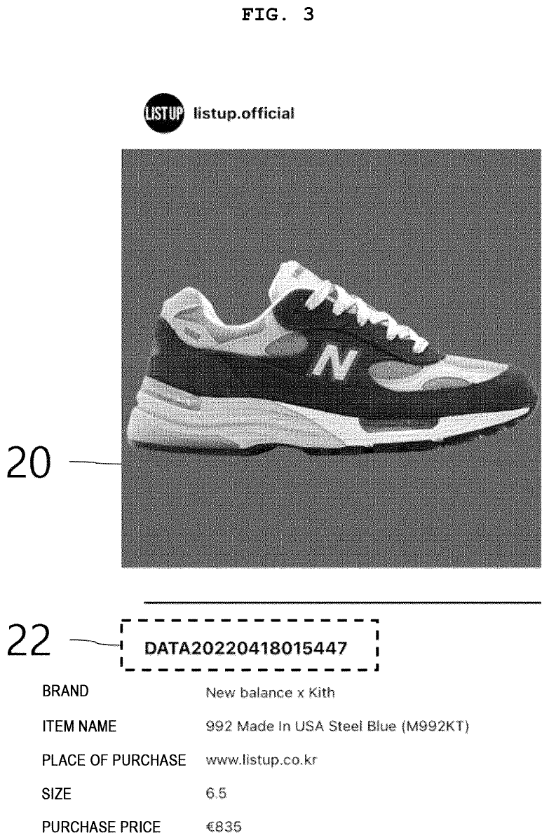

The server S may provide, to the users, a platform capable of managing their own fashion items, communicating with other users about fashion items, and even trading used items. The platform is implemented as a specific application, and the application may be installed on each user's user terminal (e.g., a smartphone, a tablet PC, or the like). The application for managing, sharing, viewing, trading, etc. fashion items may be provided by an operator of the server S. FIGS. 3 to 9 show user interfaces of an application implemented on a user terminal according to one embodiment.

The users may enter attribute information (a product image, a year of release, a year of purchase, a brand, a purchase price, a place of purchase, a purchase route, purchase details, a condition (frequency of use or feeling of use), a type (shoes, clothing, top, bottom, watch, accessory, bag, or the like), a unique product number, and the like) for each of their fashion items into the application. The attribute information of a fashion item may be referred to as item data, and the act of a user entering the item data for a new fashion item into the application may be referred to as data issuance. A data archive of the user may be generated by the user issuing the data. Data archive may refer to item data of an individual fashion item entered by a specific user (individual data archive), or may refer to a collection of item data of all fashion items entered by a specific user (entire data archive). The purchase details may include information about purchase details made online or offline (a place of purchase, seller information, a payment method, a purchase date and time, a purchase receipt, and the like). Hereinafter, the purchase details may refer to a purchase receipt, and a purchase receipt is described as a representative example of the purchase details, but is not limited thereto.

The server S may assign a unique data number to the data archive for an individual fashion item. Since the item data corresponds one-to-one to the unique data number, when a first user U1 issues data about his/her sneakers, a second user U2 may not issue his/her data or register a fake second-hand transaction item with the image of the sneakers uploaded by the first user U1. That is, by assigning the unique data number to each data issuance, the reliability of the source of the fashion item and the transparency of second-hand transactions may be improved. The unique data number may be inserted as a watermark into the image of the fashion item, but is not limited thereto.

The server S may pay a reward when the user issues data. The reward may be paid in the form of mileage, and mileage may be converted into cash. Similarly, the server S may also reward users (sellers or buyers) who complete a second-hand transaction. The server S may pay a reward for visiting other users' data archives. By paying the reward, it is possible to induce users to issue new data and activate second-hand transactions, thereby expecting quantitative and qualitative expansion of the platform.

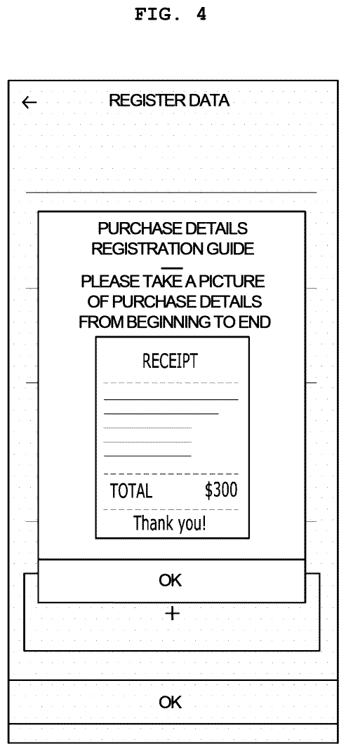

The first user U1 may enter attribute information, including images, about the fashion items he or she owns into the application and list his or her fashion items. FIG. 3 shows an archive of data issued by the first user U1 for his/her sneakers, according to one embodiment. Referring to FIG. 3, a data archive 20 includes an image and attribute information of a fashion item and may be assigned a unique data number 22. FIG. 4 shows a purchase receipt input screen requested to issue data, according to one embodiment. As in the embodiments described above, data may be issued based on purchase details. However, entering the purchase details (e.g., a purchase receipt) is not required for data issuance to be completed.

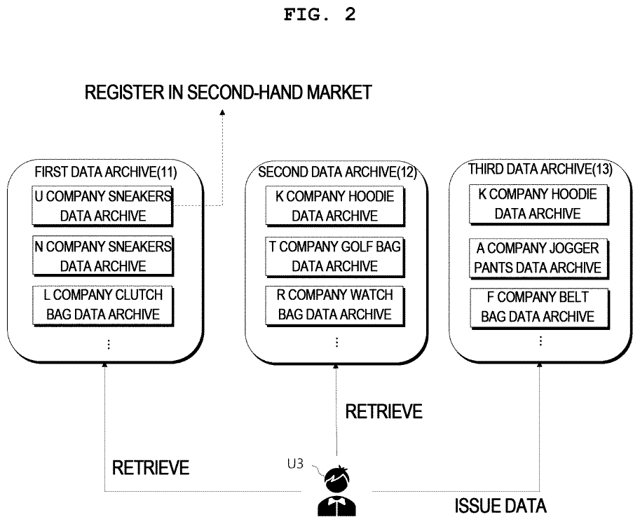

The second user U2 may enter attribute information, including images, about the fashion items he or she owns into the application and list his or her fashion items. A third user U3 may enter attribute information, including images, about fashion items he or she owns into the application and list his or her fashion items. The server S may build a database including archives of data of the users. FIG. 2 shows data archives stored on the server according to one embodiment.

According to one embodiment, the server S may check whether the purchase details uploaded by the user is true or check whether there are any duplicate purchase receipts.

In one embodiment, the server S may update the purchase details by linking with another server (e.g., a shopping mall server). The server S may receive a purchase record of a specific user from another server (e.g., a shopping mall server) and update the purchase record in the data archive.

A first data archive 11, a second data archive 12, and a third data archive 13 are a data archive of the first user U1, a data archive of the second user U2, and a data archive of the third user U3, respectively. Each data archive may contain individual data archives. For example, the first data archive 11 may include “U company sneakers data archive,” “N company sneakers data archive,” “L company clutch bag data archive,” and the like. “U company sneakers data archive” refers to item data including attribute information about U Company sneakers owned by the first user U1.

The third user U3 may retrieve the first data archive 11 and the second data archive 12, and may issue new data to the third data archive 13, which is his/her own data archive.

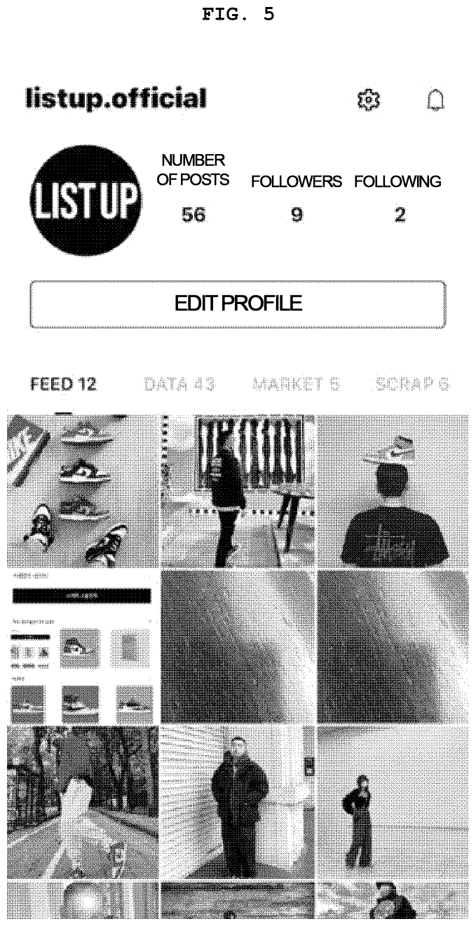

Referring back to FIG. 3, the attribute information about the fashion item may include an image of the fashion item, a unique product number, a brand, a place of purchase, size information, a purchase price, a purchase receipt, and the like. The first user U1 may register purchase details by uploading the purchase receipt when the attributes of the fashion item are entered. The issued item data may be displayed to other users as a feed post. For example, when the first user U1 issues item data about sneakers and posts the data as a feed post, another user (e.g., the third user U3 who is a follower of the first user U1) may check the sneaker post of the first user U1 in real time. FIG. 5 shows feed posts of a specific user, according to one embodiment.

All data archives of the user may be grouped into a plurality of categories so that the users may easily find a desired fashion item within the application. For example, the data archive may be automatically classified by various criteria such as a brand, a type (shoes, tops, bottoms, accessories, hats, glasses, or the like), a frequency of use, a purpose, a place of purchase, a purchase price, and the like based on entered attribute information, and the server S may automatically generate at least one criterion for grouping and group fashion items according to the generated criterion.

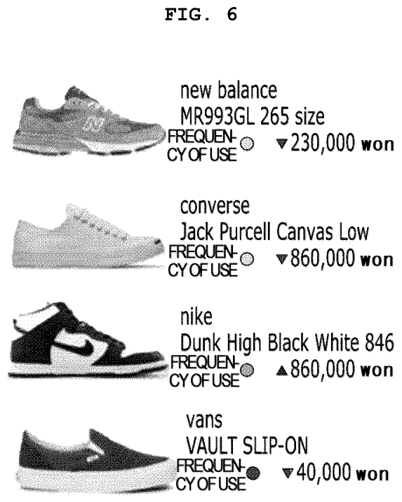

The frequency of use may be used to select information about fashion items worn by the user from his or her all data archives and transmit the information to a server S, and the server S may generate frequency-of-use information based on the received wearing information. In the embodiment, the server S may transmit a notification message to the user at regular intervals (e.g., daily or weekly) to prompt the user to enter each fashion item that he or she has ever worn into the data archives. The frequency of use may be displayed on the application (FIG. 6). Referring to FIG. 6, a level of frequency of use may be differently displayed for each item. The frequency of use is not visible to others. Based on the frequency of use, the user may select unused items.

The user may enter at least one hashtag for the data archive or feed post of the fashion item. The user may search for the fashion items the user wants among numerous fashion items of various users (U1, U2, U3,) uploaded to the server S by entering a keyword in a search box. The keyword may be a brand, an item type, a fashion style, a unique product number, or the like, but is not limited thereto.

The user may capture purchase details from an online shopping mall through a mobile browser/screen capture function within an operating range of the application and enter attribute information about fashion items based on the captured purchase details. According to one embodiment, the attribute of the fashion item may be entered by the user or by the server S. For example, when the user enters the unique product number for the fashion item, the server S may automatically enter, into the data archive, information (the brand, the product image, the year of release, and the like) corresponding to the unique product number on the web in a crawling manner or the like based on the unique product number. Alternatively, at least some of the attribute information may be entered by the user photographing a barcode or QR code on a tag attached to the product the user has purchased. The server S may directly use the mobile browser/screen captured by the user as purchase-details information or in recognize text the mobile browser/screen to generate the purchase-details information. Alternatively, the server S may receive the purchase details of the user from a server in the purchase-place the user by linking with the server in the purchase-place. Even when the user does not directly enter the purchase-details information, the server S may obtain the purchase-details information of the user. The user may also enter attribute information about offline purchases, and the attribute information about the fashion items may be entered in the same way, except that the attribute information is entered by photographing rather than capturing.

The user may retrieve data archives of other users. For example, the first user U1 may check the fashion item owned by the second user U2 by retrieving the data archive of the second user U2. The first user U1 may be a follower of the second user U2, but is not limited thereto.

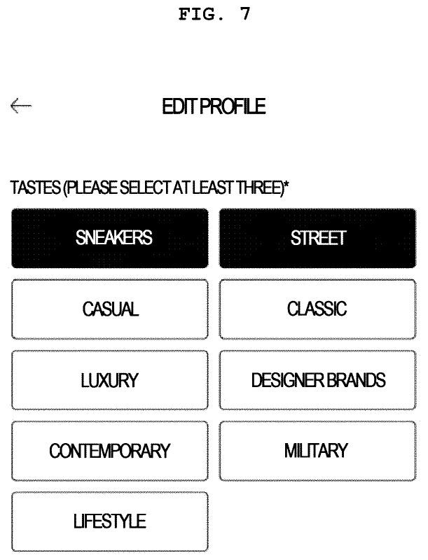

The server S may analyze attribute information about fashion items in the data archive of each of the users and determine the user's preferred fashion style. Alternatively, the server S may allow users to select at least one of the listed fashion style keywords. FIG. 7 is a screen showing keywords that may indicate a user's preferred fashion style on an application according to one embodiment. For example, the user may select at least one of the following categories: Sneakers, Street, Casual, Classic, Luxury, Designer Brand, Contemporary, Military, and Lifestyle.

According to one embodiment, the server S may determine that two users have similar preferred fashion styles when the keywords selected by the two users are common to a standard number (e.g., three) or more. According to one embodiment, the server S may determine other users whose preferred fashion style is similar to the user based on at least one of information values and taste values of other users followed by the user. According to one embodiment, the server S may determine other users whose preferred fashion style is similar to the user based on at least one of information values and taste values of other users following the user. In one embodiment, the server S may determine other users whose preferred fashion style is similar to the user or determine a list of items that the user may be interested in based on a hashtag entered into the data archive of the user. The information value represents a characteristic of the data archive of the user, and may be a multidimensional vector value obtained from the data archive of the user.

The server S may provide a list of users whose preferred fashion style is similar to the user or a list of items that the user may be interested in based on the preferred fashion style of the user. For example, the server S may display a fifth user U5 (not shown) whose preferred fashion style is similar to the first user U1 as a recommended following and provide a data archive of the fifth user U5 to the first user. The user may select users to follow or share fashion information based on a list of other users whose preferred fashion style is similar to the user, which is provided by the server S. The user may retrieve second-hand transaction target goods registered by other users on the corresponding list. In addition, second-hand transaction target goods posted by other users whose preferred fashion style is similar to the user may be preferentially exposed to the second-hand market.

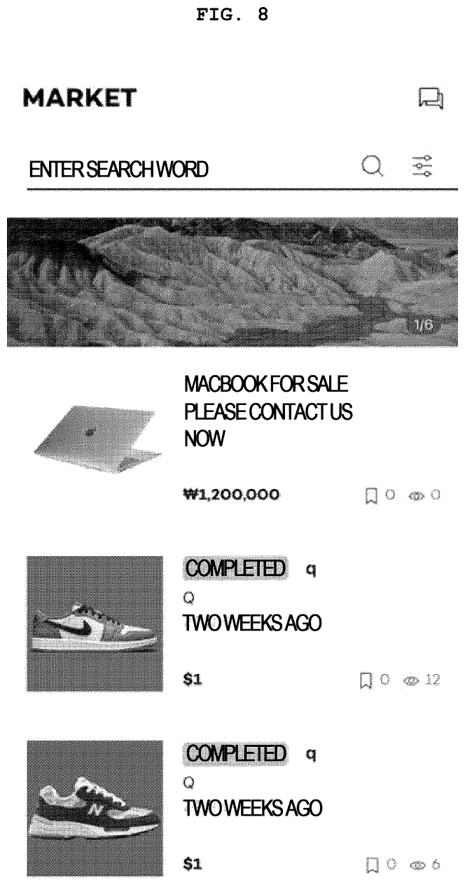

According to one embodiment, the user may register one of a plurality of fashion items stored in his or her data archive as a sale item (hereinafter, a “second-hand transaction target item”) in the second-hand market. By registering one fashion item in the second-hand market, the second-hand transaction target item in the data archive of the user may be marked as “for sale.” FIG. 8 shows a second-hand market on an application, according to one embodiment. According to one embodiment, a button for the first user to register a second-hand transaction target item in a second-hand market may be positioned on the application, and when the first user presses the button, the second-hand transaction target good may be registered in the second-hand market on the application. Another user may start transaction by looking at the second-hand transaction target items in the second-hand market and expressing his or her intention to make a transaction in a chat or the like when there is an item the user wants to make the transaction.

When a specific fashion item is registered as a second-hand transaction target item, the data archive of the user for the specific fashion item may be copied or transferred to the second-hand market. For example, when the first user issues data on a specific fashion item, all entered pieces of attribute information may be copied to the second-hand market, and other users may check the pieces of attribute information about the corresponding second-hand transaction target item.

In one embodiment, purchase details among pieces of attribute information is not exposed to other users, but purchase details (e.g., purchase receipt) among pieces of attribute information about the second-hand transaction target items displayed on the second-hand market may be exceptionally exposed to other users. Since the purchase details contain sensitive information such as credit card information, a name, a purchase place, and the like, exposure to others is limited, but when an item is registered as a second-hand transaction target item, the purchase details (e.g., purchase receipt) may be exceptionally exposed to increase the reliability of the second-hand transaction.

The second-hand transaction target goods of the second-hand market may be differently exposed to each user. According to one embodiment, the server S may preferentially expose, to the first user U1, second-hand transaction target goods registered by other users whose preferred fashion style is similar to the first user U1. In the embodiment, the second-hand transaction target item registered by a user whose preferred fashion style is similar to the first user U1 may be first exposed to the second-hand market displayed on the user terminal of the first user U1, and the second-hand transaction target item registered by a user whose preferred fashion style is similar to the second user U2 may be first exposed to the second-hand market displayed on the user terminal of the second user U2. This may minimize items left unused by users by reducing the search cost for fashion items and facilitating quick transactions.

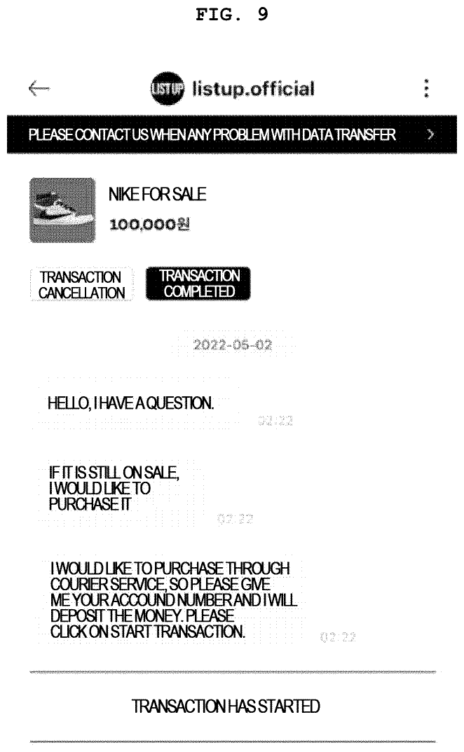

A purchaser of the second-hand transaction target item may express his or her intention to purchase to a seller, and the seller may change a state of the second-hand transaction target item from a “for sale” state to an “in transaction” state by pressing a transaction start button on the application. Once the transaction is completed, the state of the second-hand transaction target item is changed to a “Transaction completed” state. Each piece of state information (for sale, in transaction, transaction completed, or the like) of the second-hand transaction target item may be displayed to other users. Each piece of state information may be displayed not only on the second-hand market but also in the data archive of each of the users. Therefore, the user may look at the data archives of the other users and find out that a his or her favorite fashion item is for sale and move to the second-hand market. Alternatively, the user may check fashion items that other users have registered in the second-hand market and express his/her intention to purchase the fashion items to the other users. FIG. 9 shows a chat window on an application for trading a second-hand transaction target item.

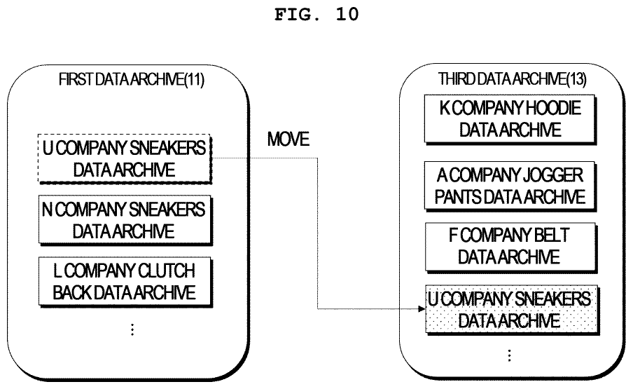

When the transaction is completed, the data archive related to the second-hand transaction target item may be moved to an account of the purchaser. For example, when the third user U3 purchases the sneakers in FIG. 2 from the first user U1, item data related to the sneakers may be moved from the account of the first user U1 to the account of the third user U3. According to one embodiment, a data issue number (DATA20220418015447) may also be moved to the data archive of the third user U3. The data archive related to the sneakers may be deleted from the data archive of the first user U1. FIG. 10 shows the first data archive 11 and the third data archive 13 of the first user U1 after the second-hand transaction is completed.

Once the transaction is completed, a transaction price may be uploaded to the server S. A second-hand transaction price of an item identical to the second-hand transaction target item may be updated based on the transaction price uploaded to the server S. The updated second-hand transaction price may be used to provide second-hand transaction market price information. According to one embodiment, the server S may provide second-hand market price information about a specific fashion item. The server S may provide the second-hand market price information based on the unique product number. The second-hand transaction market price information may include transaction price information from transactions that have occurred through the application over a predetermined period of time in the past for the specific fashion item. According to one embodiment, clicking a unique product number of the specific fashion item in the data archive on the application may display information on a place where the corresponding fashion item is sold (web link), a new product price, and the second-hand transaction market price.

The server S may provide a social media service or community where the user may show off a purchased fashion item and share styling by utilizing the item data. The user may utilize the application to show off his or her fashion item and provide a styling sharing function. For example, the application may provide a function of linking issued data with other existing social media (Instagram, Facebook, or the like).

The above-described embodiments have been described with a focus on fashion items, but are not limited to fashion items and may be equally applied to other types of items such as electronic products, records, souvenirs, photographs, watches, and the like.

The descriptions are intended to provide example configurations and operations for implementing the present invention. The technical spirit of the present invention will include not only the embodiments described above, but also implementations to be obtained by simply changing or modifying the above embodiments. In addition, the technical spirit of the present invention will also include implementations to be easily achieved by changing or modifying the embodiments described above.

1. A system for managing a fashion item, comprising:
a server; and
user terminals that are accessible to the server and on which a predetermined application is installed,
wherein the user terminals are owned by users including a first user, a second user, and a third user,
each of the users issues data by entering an image of a fashion item that the user owns and attribute information including at least one of a purchase year, a brand, a purchase price, a type, or a purchase receipt image of the fashion item into the application,
the server stores a data archive of each of the users including the data of each of the users,
the second user is able to retrieve the fashion item owned by the first user by retrieving the data archive of the first user, the purchase receipt image for the fashion item not being exposed to the second user,
a state of a second-hand transaction target item that is one of a plurality of fashion items stored in the data archive of the first user is changed to a for-sale state and displayed to the users by the first user registering the second-hand transaction target item as a sale item in a second-hand market, the second user and the third user are able to check the purchase receipt image for the second-hand transaction target item, and the state of the second-hand transaction target item is changed to an in-transaction state and displayed to the users by the third user expressing an intention to transact to the first user, and
each of the users selects at least one of fashion style keywords listed on the application, and the server provides the first user with a list of users whose preferred fashion style is similar to the first user based on the selected fashion style keyword.

2. The system of claim 1, wherein when the transaction is completed, the state of the second-hand transaction target item is changed to a transaction-completed state and displayed to the users, and data of the second-hand transaction target item is moved from an account of the first user to an account of the third user.

3. The system of claim 2, wherein the attribute information further includes a unique product number of the fashion item,
the server provides second-hand market price information about the fashion item based on the unique product number, and
when the transaction is completed, a transaction price of the second-hand transaction target item is uploaded to the server so that the transaction price is reflected in the second-hand market price information.

4. The system of claim 1, wherein second-hand transaction target goods of the second-hand market are differently exposed to each user,
a second-hand transaction target item registered by a user whose preferred fashion style is similar to the first user is first exposed to the second-hand market displayed on the user terminal of the first user, and
a second-hand transaction target item registered by a user whose preferred fashion style is similar to the second user is first exposed to the second-hand market displayed on the user terminal of the second user.
